(19) United States
(12) Patent Application Publication
(10) Pub. No.: US 2018/0158589 A1
(43) Pub. Date: Jun. 7, 2018

(54) DOUBLE-POLE VOLTAGE TRANSFORMER

(71) Applicant: ABB Schweiz AG, Baden (CH)

(72) Inventors: Piotr Liszewski, Przasnysz (PL); Jaroslaw Chorzepa, Przasnysz (PL)

(21) Appl. No.: 15/891,880

(22) Filed: Feb. 8, 2018

Related U.S. Application Data
(63) Continuation of application No. PCT/PL2016/000065, filed on Jun. 24, 2016.

(30) Foreign Application Priority Data
Aug. 10, 2015 (PL) W.124310

(51) Int. Cl. H01F 27/02; H01F 38/26; H01F 27/06

(52) U.S. Cl. CPC H01F 27/022; H01F 27/06; H01F 38/26

(57) ABSTRACT

The application invention generally deals with a double-pole voltage transformer enclosed in a tight enclosure made in the form of a resin cast comprising a central element integrated with a base and comprising circumferential sheds and two bushings situated above the circumferential sheds on the central element. The central element has the form of a circular cylinder situated with its side wall horizontally on the base plane, and the circumferential sheds are situated around the central element only in the area of the contact between the central element and the base, and above the circumferential sheds there are side elements of the cast forming side sheds, and above the side sheds there is situated a circumferential top shed surrounding a fragment of the side surface of the central element, and the bushings are detachably joined with the central element through projections respectively.

The invention deals with a MV single-phase double-pole voltage transformer in resin insulation. The voltage transformer is applicable in medium voltage measuring and protection electric power systems and as a power supply component in medium voltage switch-disconnector systems.

There is known a double-pole voltage transformer of the type TDO manufactured by ABB s.r.o. org. Unit EJF. That transformer is tightly closed in an enclosure made as a resin cast comprising a central element in the shape of an elliptical cylinder fitted with circumferential sheds situated on the side surface of the cylinder perpendicularly to the longitudinal axis of the cylinder. The central element is situated with one base of the cylinder on an elliptical base and it is integrated with it. Additionally, the central element is integrated with two bushings situated above the circumferential sheds on the other base of the cylinder, this base being convex.

In the above presented solution, insulating bushings and the transformer body are connected with high voltage and low voltage coils in one resin cast, and the high voltage coil of the primary winding forms one whole with the insulating bushings. Making of the cast requires the use of expensive moulds, which increases the manufacturing costs. At the same time, the place where the bushings are joined with the body is a place of lowered mechanical strength of the cast, which can result in cracks in the resin in that place due to shrinkage of resin in the hardening process, caused by changes in temperature.

The essence of the invention is that a double-pole voltage transformer tightly closed in an enclosure made as a resin cast containing a central element integrated with a base and comprising circumferential sheds and two bushings situated above the circumferential sheds on the central element, is that the central element has the form of a circular cylinder situated with its side wall horizontally on the base plane, with the circumferential sheds placed around the central element only in the area of contact between the central element and the base, and above the circumferential sheds there are located side elements of the cast forming side sheds which are integrated with the front surfaces of the central element, and above the side sheds there is situated a circumferential top shed surrounding a fragment of the side surface of the central element, and the bushings are detachably joined with the central element by projections which are situated above the circumferential top shed and they are formed in the shape of truncated cones integrated with the central element, in which projections there are situated HV complete terminals.

Preferably the central element has a partition in the shape of a segment of a round shed and adjoining the upper surface of the central element in a plane perpendicular to the longitudinal axis of the central element, in the middle of its length “L”.

Preferably the side walls of the base situated along the side walls of the central element are fitted with oblong sockets having the shape of semicircular longitudinal hollows.

Preferably the circumferential sheds, the side sheds and the circumferential top shed are situated parallel to one another and in planes parallel to the bottom surface of the base, and they have a fixed inter-shed spacing “S” and an alternately variable overhang “P1”, “P2” between the adjacent sheds.

Preferably the longitudinal axes of the bushings are divergent to one another and they deviate from a vertical line in a plane parallel to the planes of the walls of the base by an angle β situated in a plane perpendicular to the bottom surface of the base. In their bottom part, the high voltage bushings have centrally situated cavities in the shape of truncated cones, which shape corresponds to the shape of the projections of the central element.

Preferably the contact surfaces between the projections and the cavities in the bushings are sealed with an insulating and sealing compound.

The advantage of the double-pole voltage transformer according to the invention is a reduction in its manufacturing cost, increased mechanical strength of the cast and elimination of the risk of damage to the place where the bushings are joined with the transformer body.

An embodiment of the invention is shown in the drawing, where:

FIG. 1—shows a front view of the transformer in isometric projection,

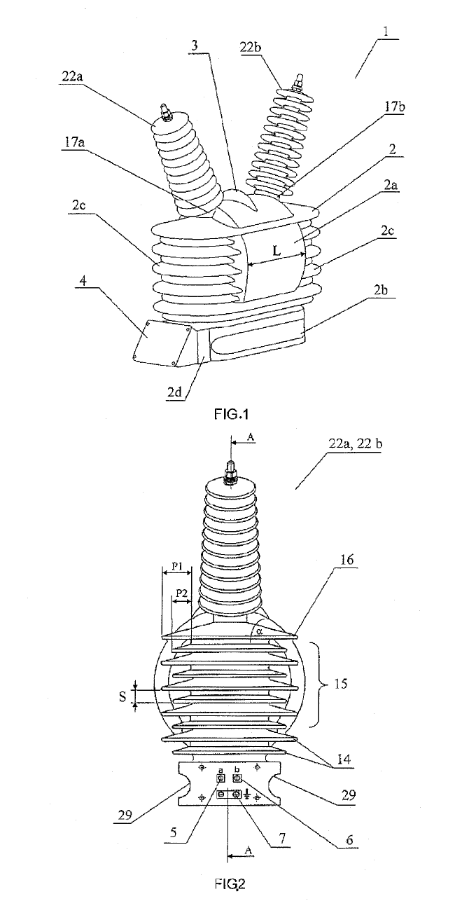

FIG. 2—shows the transformer after the terminal box has been removed, in a side view,

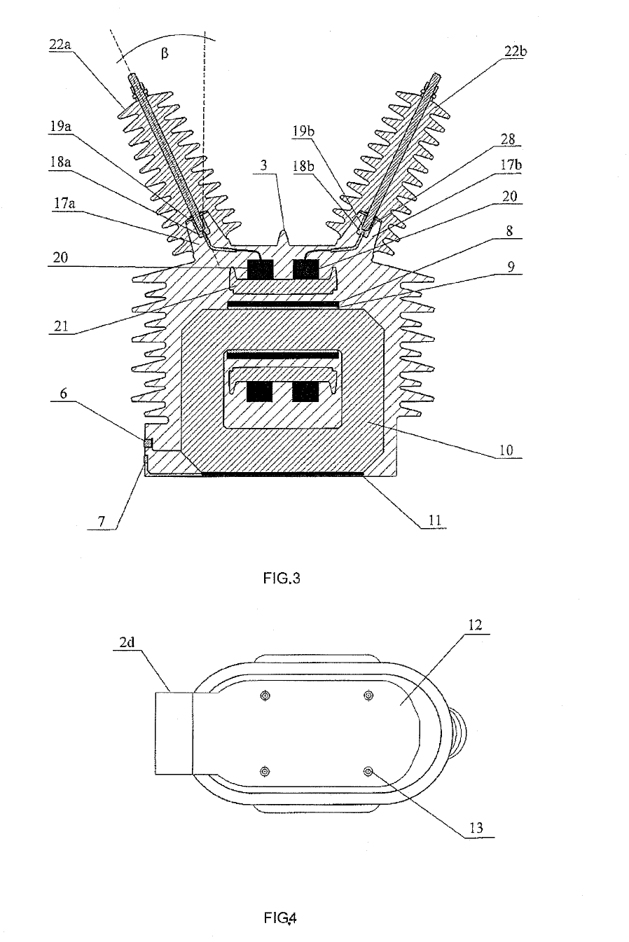

FIG. 3—shows the transformer from FIG. 2, in section A-A,

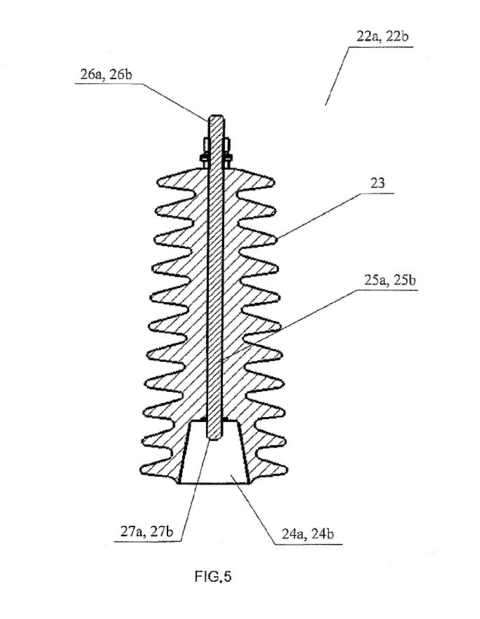

FIG. 4—shows the transformer in a bottom view,

FIG. 5—shows the transformer bushing from FIG. 2, in section A-A.

The double-pole voltage transformer 1 comprises a tight enclosure 2 made as a resin cast with a central element 2a, a base 2b and side elements of the cast 2c.

The element 2a has the form of a circular cylinder situated horizontally on the base 2b. The base 2b has the form of a cuboid with rounded edges. A cuboidal side element 2d integrated with the base 2b adjoins the base, more specifically one of its side walls.

The element 2a of the transformer 1 has a partition 3 in the shape of a segment of a round shed adjoining the upper surface of the element 2a, in a plane perpendicular to the longitudinal axis of the element 2a, in the middle of its length “L” defined as the distance between the front surfaces of the cylinder of the central element 2a.

A terminal box 4 is attached to a side wall of the element 2d of the enclosure 2. Inside the box 4, in a side wall of the element 2d there are located two complete terminals nn 5, 6 and an earthing terminal 7. The terminals 5 and 6 are galvanically connected inside the enclosure 2 with a low voltage winding nn 8. The winding nn 8 is wound on an insulating tube 9 fixed on a core 10 secured in a yoke 11 located in the enclosure 2. The earthing terminal 7 is galvanically connected inside the enclosure 2 with the yoke 11 and the core 10.

On the bottom surface 12 of the base 2b there are located assembly elements 13 in the form of threaded conducting inserts which are used to fix the transformer 1 to a support structure in the form of a plate or rails, not shown in the drawing. The elements 13 are galvanically connected inside the enclosure 2 with the earthing terminal 7.

The place of contact of the side surface of the element 2a with the base 2b is screened by circumferential bottom sheds 14. Above the sheds 14 there are situated, on both sides, semicircular side sheds 15, over which, in the upper part of the enclosure 2, a circumferential upper shed 16 is situated.

The sheds 14, 15, 16 are situated parallel to one another and on planes parallel to the bottom surface 12 of the base 2b of the transformer 1, with a fixed inter-shed spacing S, angle of inclination of the sheds a and an alternating overhang P1, P2, with P1>P2 .

Above the shed 16, at the place where it is joined to the surface of the central element 2a of the enclosure 2, there are situated projections 17a and 17b which are integrated with the central element 2a and which have the form of truncated cones. The projections 17a and 17b are situated symmetrically relative to the partition 3. Complete HV terminals 18a and 18b, fitted with threaded holes 19a and 19b respectively, are situated in the projections 17a and 17b. The terminal 18a is galvanically connected inside the enclosure 2 with the beginning of an HV winding 20, and the terminal 18b is galvanically connected inside the enclosure 2 with the end of the HV winding 20. The HV winding 20 is concentrically wound on a carcass 21. The carcass 21 is fixed on the core 10 concentrically and externally to the insulation tube 9.

Bushings WN 22a and 22b are detachably fixed on the projections 17a and 17b. The HV bushings 22a, 22b are made as resin casts fitted with circumferential bushing sheds 23. In the bases of the bushings 22a, 22b, there are cavities 24a, 24b respectively having the shapes of truncated cones situated coaxially to the longitudinal axis of the bushings 22a, 22b, and their shape corresponds to the shape of the projections 17a, 17b. In the longitudinal axes of the bushings 22a, 22b there are located conductive rods 25a, 25b respectively whose ends protrude outside the resin casts of the bushings 22a, 22b and they form first connections 26a, 26b and second connections 27a, 27b respectively. The connections 26a, 26b, 27a and 27b have threads, not shown in the drawing. The bushings 22a and 22b are fixed on the projections 17a and 17b respectively, by screwing the connections 27a, 27b located in the cavities 24a, 24b into the terminals 18a and 18b. The projections 17a, 17b fill the cavities 24a, 24b respectively, and the surfaces of contact between the external walls of the projections 17a, 17b respectively, and the surfaces of the cavities 24a, 24b are sealed with an insulating and sealing compound 28.

The longitudinal axes of the bushings 22a, 22b are divergent to each other and they coincide with the longitudinal axes of the projections 17a and 17b respectively and they deviate from a vertical line symmetrically with respect to the partition 3 in a plane parallel to the planes of the walls of the base 2b by an angle β situated in a plane perpendicular to the bottom surface 12 of the base 2b.

Sockets 29 for a mounting bracket, not shown in the drawing, are located on the side walls of the base 2b below the front surfaces of the element 2a screened by the circumferential sheds 14. The sockets 29 have the shape of semicircular longitudinal hollows. The diameter of the sockets 29 is selected to correspond to the diameter of the tubes of the mounting bracket, not shown in the drawing. The mounting bracket has a plate to which four arms in the form of tubes are attached. The mounting bracket makes it possible to turn the transformer 1 in a plane perpendicular to the longitudinal axis of the sockets 29, in order to set the transformer up in such way that the projections 17a, 17b point downwards. Such position of the transformer is necessary for a proper distribution of the sealing compound 28 when the connections 27a and 27b are screwed onto the terminals 18a and 18b respectively, so that the compound 28 does not overflow from the cavities 18a and 18b but is evenly distributed on the contact surfaces of the cavities 24a, 24b and of the projections 17a and 17b respectively.

### KEY TO THE DRAWING

1—the voltage transformer

2—the enclosure

2a—the central element of the enclosure

2b—the base of the enclosure

2c—the side elements of the cast

2d—the side element of the base

3—the partition

4—the terminal box

5, 6—the complete terminals nn

7—the earthing terminal

8—the winding nn

9—the insulation tube

10—the core

11—the yoke

12—the bottom surface of the base 2b

13—the assembly elements

14—the circumferential sheds

15—the side sheds

16—the circumferential upper shed

17a, 17b—the projections

18a, 18b—the complete HV terminal

19a, 19b—the threaded hole

20—the HV winding

21—the carcass

22a, 22b—the bushings

23—the sheds of the bushings

24a, 24b—cavities

25a, 25b—the conductive rods

26a, 26b—the first connections

27a, 27b—the second connections

28 —the sealing compound

29—the sockets

L—the length of the central element 2a

S—the Enter-shed spacing

α—the angle of inclination of the sheds

P1, P2—the overhang of the sheds

β—the angle of deviation of the bushings

1. A double-pole voltage transformer enclosed in a tight enclosure made in the form of a resin cast comprising:
a central element integrated with a base and comprising circumferential sheds and two bushings situated above the circumferential sheds on the central element, the central element has the form of a circular cylinder situated with its side wall horizontally on the base plane, and the circumferential sheds are situated around the central element only in the area of the contact between the central element and the base, and above the circumferential sheds there are side elements of the cast forming side sheds which are integrated with the front surfaces of the central element, and above the side sheds there is situated a circumferential top shed surrounding a fragment of the side surface of the central element, and the bushings are detachably joined with the central element through projections and respectively, which are situated above the circumferential top shed and have the shape of truncated cones integrated with the central element in which projections complete HV terminals respectively are situated.

2. The transformer according to claim 1 wherein the central element is fitted with a partition having the shape of a segment of a round shed and adjoining the upper surface of the element in a plane perpendicular to the longitudinal axis of the element in the middle of its length “L”.

3. The transformer according to claim 1 wherein the side walls of the base, situated along the side walls of the central element, are fitted with oblong sockets having the shape of semicircular longitudinal hollows.

4. The transformer according to claim 1 wherein the circumferential sheds, the side sheds and the circumferential top shed are situated parallel to one another and in planes parallel to the bottom surface of the base and they have a fixed inter-shed spacing “S” and an alternately variable overhang “P1”, “P2” between the adjacent sheds.

5. The transformer according to claim 1, wherein the longitudinal axes of the bushings are divergent to one another and deviated from a vertical line in a plane parallel to the planes of the walls of the base by an angle β situated in a plane perpendicular to the bottom surface of the base.

6. The transformer according to claim 1, wherein the high voltage bushings have in their bottom part centrally situated cavities in the shape of truncated cones, which shape corresponds to the shape of the projections of the central element, respectively.

7. The transformer according to claim 6, wherein the contact surfaces between the projections and the cavities in the bushings are sealed with an insulating and sealing compound.
